(19) United States
(12) Patent Application Publication
(10) Pub. No.: US 2013/0300704 A1
(43) Pub. Date: Nov. 14, 2013

(54) INFORMATION INPUT DEVICE AND INFORMATION INPUT METHOD

(71) Applicants: Tomonari Takahashi, Osaka (JP); Yoichi Ikeda, Osaka (JP)

(72) Inventors: Tomonari Takahashi, Osaka (JP); Yoichi Ikeda, Osaka (JP)

(21) Appl. No.: 13/989,213

(22) PCT Filed: Sep. 6, 2012
(86) PCT No.: PCT/JP2012/005672

§ 371 Date: May 23, 2013

(30) Foreign Application Priority Data
Sep. 13, 2011 (JP) 2011-199931

(51) Int. Cl. G06F 3/01; G06F 3/0488

(52) U.S. Cl. CPC G06F 3/017; G06F 3/0488
USPC 345/173

(57) ABSTRACT

The information input device is an information input device which identifies, as a touch gesture, a touch input from a user and includes: a touch sensor; and an input processing unit which identifies the touch input as the touch gesture using contact positions for identification among contact positions through which the touch input has been given to the touch sensor and which have been detected sequentially at different times within a predetermined period. The contact positions for identification excludes a contact position that is detected after a total number of contact positions detected after a start of the touch input reaches a predetermined number and that falls within a predetermined region.

### TECHNICAL FIELD

The present invention relates to an information input device and an information input method in which a touch sensor such as a touchpad or a touchscreen is used. In particular, the present invention relates to an information input device which obtains information on two or more contact positions to identify the type of a movement of a touch input when a user gives the touch input by touching a touch sensor, and controls an information device according to the type of the movement, and also relates to an information input method performed by the information input device.

### BACKGROUND ART

Touchpads are one of well-known input devices for operation of GUI screens displayed on displays included in electronics apparatuses such as a PC and a mobile phone. An information input device including a touchpad as an input interface allows a user to intuitively perform operations responsive to motions of the user's finger or thumb by moving it along the surface of the touchpad to perform an operation for pointing a cursor on the GUI screen. Furthermore, input devices in recent years allow users not only to point a cursor but also to zoom or vertically or horizontally scroll objects including documents and pictures on GUI screens by gesture operations such as rotation and flick. The rotation is an operation performed by sliding a finger or a thumb in a circle on the touchpad. The flick is an operation performed by lightly brushing the touchpad with a finger or a thumb. Users can thus perform multiple flexible and intuitive operations through a single input device (see Patent Literature (PTL) 1 and PTL 2).

### CITATION LIST

### Patent Literature

[PTL 1] Japanese Unexamined Patent Application Publication No. 2009-140210
[PTL 2] Japanese Unexamined Patent Application Publication No. 2009-217814

### SUMMARY OF INVENTION

### Technical Problem

However, in the technique disclosed in PTL 1 or in PTL 2, an input intended by a user may be falsely detected as an input of a different type.

The present invention has an object of providing an information input device including an operation unit which has increased capability of identifying gestures such as a flick and a rotation to adhere to the intention of a user, thereby solving the problem with the conventional techniques.

### Solution to Problem

In order to solve the problem with the conventional techniques, an information input device according to the present invention which identifies, as a touch gesture, a touch input from a user includes: a touch sensor; and an input processing unit configured to identify the touch input as the touch gesture using contact positions for identification among contact positions through which the touch input has been given to the touch sensor and which have been detected sequentially at different times within a predetermined period, the contact positions for identification excluding a contact position that is detected after a total number of contact positions detected after a start of the touch input reaches a predetermined number and that falls within a predetermined region.

In this configuration, identification of a touch input as a touch gesture is performed using, as positions for identification, positions which are among contact positions detected within a predetermined time and excludes contact positions detected after a total number of contact positions that are detected after a start of the touch input reaches a predetermined number and fall within a predetermined region. A user often gives a touch input with an intention for a certain time after the start of the touch input, but the input may be followed by an unintended input. Such unintended inputs are often given in a predetermined region. In consideration of this, the input processing unit identifies the touch input as a touch gesture using only a predetermined number of contact positions detected after the start of a touch input and avoids using contact positions that are detected after a total number of contact positions detected after the start of the touch input reaches a predetermined number and that falls within a predetermined region where unintended inputs are often detected. This allows more appropriate selection of items of detection information to use provided from the touch sensor. As a result, detected touch gestures matches touch gesture intended by users more accurately, and thereby capability of identifying touch gesture inputs is increased.

It should be noted that these general or specific aspects can be implemented as a system, a method, an integrated circuit, a computer program, a computer-readable recording medium such as a compact disc read-only memory (CD-ROM), or as any combination of a system, a method, an integrated circuit, a computer program, and a computer-readable recording medium.

### Advantageous Effects of Invention

The information input device according to the present invention is capable of more accurate detection of a touch gesture as intended by a user, and thus having increased capability of identifying touch gesture inputs.

### BRIEF DESCRIPTION OF DRAWINGS

FIG. 1 is a block diagram showing configuration of an information input device in Embodiment 1.

FIG. 2 illustrates points through which a user has given a touch input to a touch sensor.

FIG. 3 shows an example of appearance of a remote control which is an information input device.

FIG. 4 illustrates points through which a user has given a touch input to the touch sensor.

FIG. 5 illustrates points through which a user has given a touch input to the touch sensor.

FIG. 6 illustrates a specific example of a predetermined region set as a rejection region.

FIG. 7 illustrates detected points detected by the detection unit on a path of a motion of a finger on the touch sensor.

FIG. 8 is a graph on which the detected points are mapped in a two-dimensional coordinate system having time t and a vertical axis y.

FIG. 9 illustrates detected points detected by the detection unit on a path of a motion of a finger on the touch sensor.

FIG. 10 illustrates how a touch gesture is identified as a rotation from a plurality of detected points.

FIG. 11 illustrates how a touch gesture is identified as a rotation from the plurality of detected points.

FIG. 12 is a flowchart indicating steps in information input processing performed by an input processing unit of the information input device.

FIG. 13 illustrates an example of a problem that occurs when the technique disclosed in PTL 2 is applied to a touch sensor having a protrusion.

FIG. 14 is a block diagram showing configuration of an information input device in an embodiment other than Embodiment 1.

FIG. 15 illustrates a specific operation of the region changing unit.

### DESCRIPTION OF EMBODIMENTS

(Underlying Knowledge Forming Basis of the Present Invention)

The inventors of the present invention have found the following problem with a stylus detection device mentioned in the section of “Background Art”.

The information input device disclosed in PTL 1 includes: an operation unit having a touch sensor; a memory unit which stores locations of two points, that is, a starting point and an end point of an input to the operation unit; an input direction determination unit which determines the direction of the input from the locations of the two points of the starting point and the end point; and a control unit which changes allocation of an operating region on the operation unit. This configuration allows the user to control the allocation of the operating region including operation keys using the moving direction of a fingertip from a starting point to an end point on the touch sensor, so that the user can operate the information input device without paying attention to the orientation of the information input device or the orientation of the operating region. The user can operate the information input device by “touch operating” without having the operating region including operation keys in the sight of the user.

In this manner, general information input devices operable using touch gestures identify the type of a touch gesture based on a series of information items on two or more contact positions detected by a touch sensor, and determine the type of control of an information device according to the identified type of the touch gesture. The “series of information items” means a group of detected points to be a basis of identification of a touch gesture. When any of the items of location information among a stored series of items of information on contacts does not match intent of the user, there is a problem that identification of a touch gesture may give a result which does not reflect a touch gesture intended by the user.

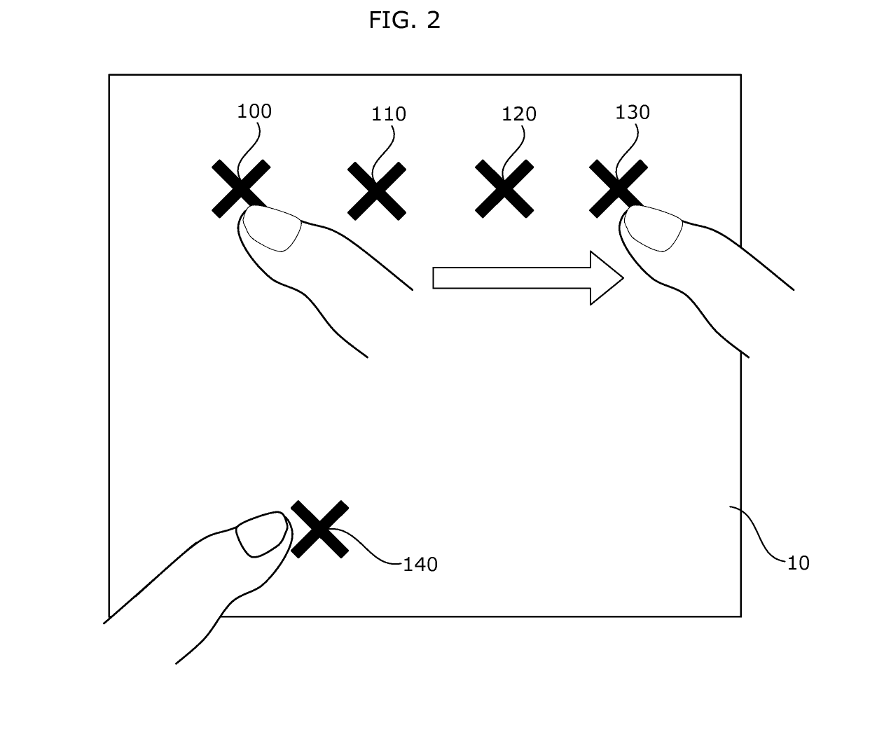

This problem will be described below using FIG. 2. FIG. 2 illustrates points through which a user has given a touch input to a touch sensor 10. Detected points 100 to 140 are points of detected contacts made by the user, and are numbered in ascending order according to time of detection. The detected touch input illustrated in FIG. 2 is given by the user by sliding a right finger from left to right, that is, from the detected points 100 to 130 and taking the right finger off the touch sensor, while inadvertently touching the detected point 140 with a left finger which is immediately taken off the touch sensor. Except the detected point 140 corresponding to the input unintended by the user, it is possible to determine from the detected points 100 to 130 that the user has moved a right finger from left to right. Actually, however, the detected point 100 is recognized as a starting point of the detected touch input, and the detected point 140 is recognized as an end point thereof. When the technique disclosed in PTL 1 is applied to the case of the detected points 100 to 140 illustrated in FIG. 2 and a touch input is thereby identified according to the moving direction of two points of a starting point and an end point, the touch gesture is identified as a downward motion from an upper region of the touch sensor 10. Thus, there is a problem that a touch gesture is identified as an information input differently from an intention of a user when a series of items of information on a touch input given by the user includes at least one point detected at a location unintended by the user.

In an information input method using a touch sensor disclosed in PTL 2, touch events in an edge region of a touch sensor panel are selectively rejected to minimize detection of unintended operations. More specifically, PTL 2 discloses a method for selectively rejecting a contact on a touch sensor panel when the touch is made in an edge region of the touch sensor panel where a user is likely to give an unintentional input. This method prevents the touch sensor panel from detection of contacts unintentionally made by the user. In addition, PTL 2 also discloses a method in which certain exceptions are provided to the rejection of contacts at an edge of a touchscreen. In an exemplary exception, when a contact is detected in a main region of a touch sensor and recognized as part of a specific gesture, a contact is not rejected even after a finger or a thumb with which the contact is made is moved into an edge part of the touch sensor.

However, the configuration disclosed in PTL 2 may cause the following problem, depending especially on the shape or characteristics of the touch sensor.

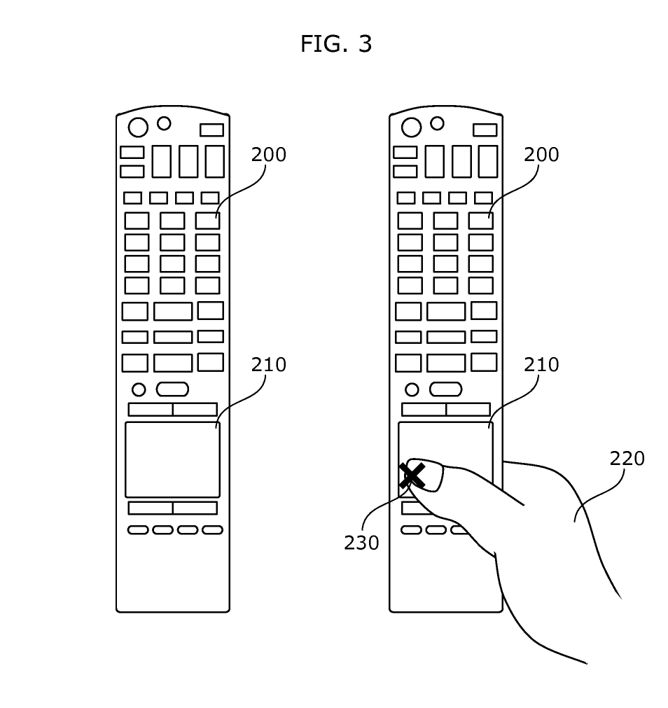

When a remote control for home appliances such as a television set or a digital recorder is an information input device having a small touch sensor, a user may hold the information input device while naturally touching an edge part of the touch sensor (that is, a region on which contacts are rejected). FIG. 3 shows an example of appearance of a remote control which is an information input device. As shown in FIG. 3, the information input device 200 is a remote control for a home appliance and has a touch sensor 210 and buttons which are used for input. When a user touches the touch sensor with a naturally stretched thumb of a hand 220 of the user to input information, the thumb touches a point at the left edge of the touch sensor 210 as illustrated as a detected point 230.

Furthermore, when the portion in the vicinity of the touch sensor 210 is higher than the sensor portion, a finger or a thumb of the user may be moved along the edge of the touch sensor 210 after coming into contact with the portion surrounding the touch sensor 210.

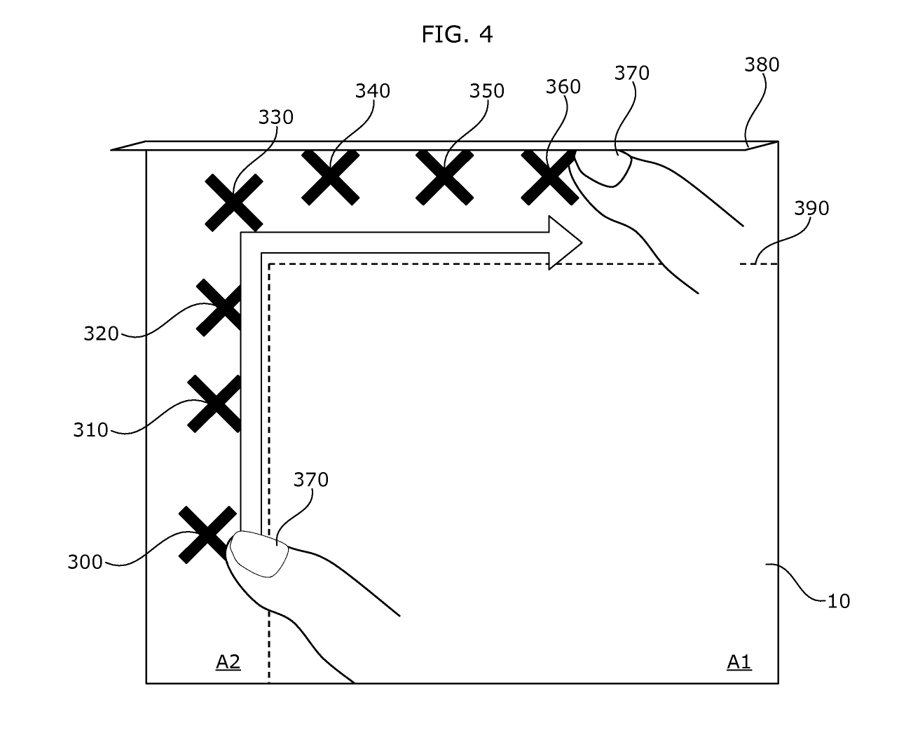

This case will be described below using FIG. 4. FIG. 4 illustrates the surface of the touch sensor 10. There is a rise 380 on the upper edge of the touch sensor 10. A border line 390 represented as a dashed line with an elbow separates the touch sensor 10 into a main region A1 and an edge region A2. The touch sensor 10 has the edge region A2 lying left of and above the border line 390 and the main region A1 covering the rest.

Detected points 300 to 360 are examples of points which are on a path of contacts made by a finger of a user and detected by the touch sensor 10 when the user makes an upward flick (see hollow arrow in FIG. 4) from a lower region of the touch sensor 10. The user moves a finger or a thumb upward from the detected point 300 to the detected point 330. Then, at the detected point 330, a finger (or a thumb) 370 of the user hits against the rise 380 in the vicinity of the touch sensor 10, and is subsequently moved along the rise 380 of the touch sensor 10 from the detected point 330 to the detected point 360. When the point with which the user starts the touching on the touch sensor 10 with a finger or a thumb and the subsequent points are located at the left edge as illustrated as the detected points 300 to 330, and the point with which the user ends the touching on the touch sensor 10 and the preceding points are located at the top edge as illustrated as the detected points 330 to 360, the flick shown in FIG. 4 is not detected using a method disclosed in PTL 2 in which all contacts in the edge region A2 are rejected.

In contrast, when the detected points 300 to 360 are recognized as part of a gesture by using a method disclosed in PTL 2 in which the detected points are exceptions to information to be rejected and are all used as valid points, direction of the gesture is determined from the starting point to the end point, that is, the detected point 300 and the detected point 360, and is thereby recognized as a diagonal gesture from the lower-left region to an upper-right region. That means that the information input device recognizes a flick input which the user gives as an upward flick as a diagonal flick input from the lower left to the upper right.

In either of the above methods, the gesture is not recognized as an information input intended by the user. The user thus needs to perform an operation to correct the false recognition, which causes a problem of poor usability.

In addition, another problem occurs when the touch sensor 10 detects contact positions less frequently.

For example, when a user gives a flick by making a short contact to the touch sensor 10, the touch sensor 10 detects few points.

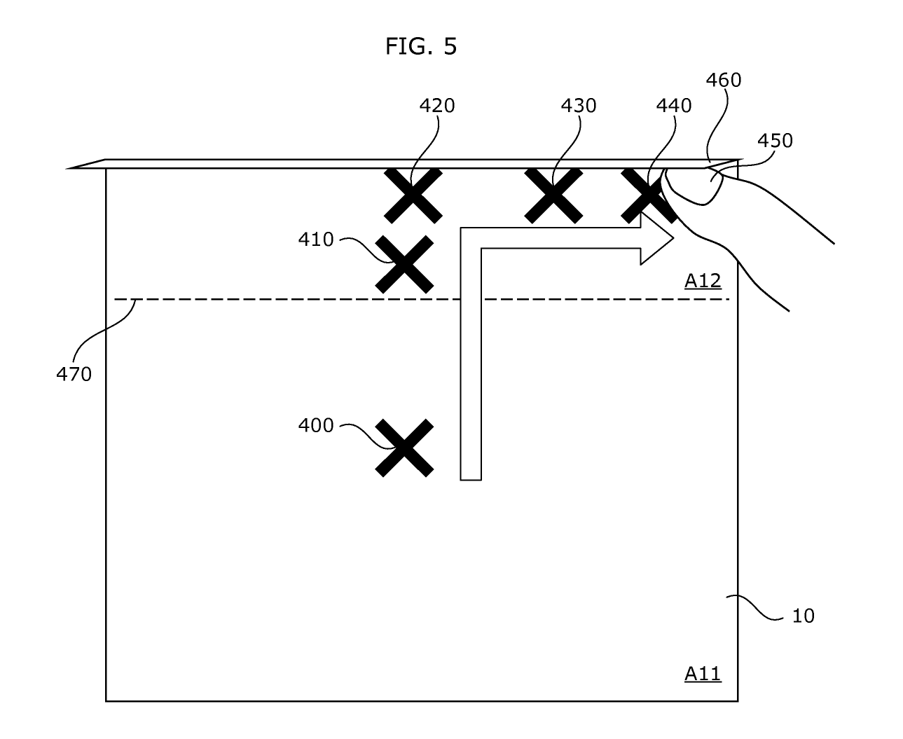

This problem will be described below using FIG. 5. FIG. 5 illustrates the problem which occurs when a short contact is made to the touch sensor 10 having a rise 460 in the vicinity of the touch sensor 10 as with the case shown in FIG. 4. Detected points 400 to 440 are points of detected contacts made by the user, and are numbered in ascending order according to time of detection. A border line 470 represented as a dashed line separates the touch sensor 10 into an edge region A12 and a main region A11. The touch sensor 10 has the edge region lying above the border line 470 where contacts made to the touch sensor 10 may be rejected. The touch sensor 10 also has the main region A11 below the border line 470. The user moves a finger or a thumb upward from the detected point 400, which is the starting point, to the detected point 420. In this case, the user intends to give an upward flick. However, at the detected point 420, the finger hits against the rise 460 in the vicinity of the touch sensor 10, and is subsequently moved rightward along the rise 460 of the touch sensor 10.

In this case, when points in the edge region are ignored as described in PTL 2, a series of items of position information to be used for recognition of the touch gesture includes only the detected point 400. The touch sensor 10 thus fails to detect the direction of the touch gesture. In this case, the flick is not detected. The detection result shows that no touch gesture has occurred, which is different from the user's intention.

On the other hand, when all the detected points 400 to 430 are recognized as part of a gesture and are used as valid position information, the gesture is recognized as a diagonal flick from the lower left to the upper right from the detected point 400, which is the starting point, and to the detected point 440, which is the end point. This detection result is also different from the upward flick intended by the user.

In either of the above methods, the gesture is not recognized as an information input intended by the user. The user thus needs to perform an operation to correct the false recognition, which causes a problem of poor usability.

In order to solve these problems, an information input device according to an aspect of the present invention is provided which identifies, as a touch gesture, a touch input from a user includes: a touch sensor; and an input processing unit configured to identify the touch input as the touch gesture using contact positions for identification among contact positions through which the touch input has been given to the touch sensor and which have been detected sequentially at different times within a predetermined period, the contact positions for identification excluding a contact position that is detected after a total number of contact positions detected after a start of the touch input reaches a predetermined number and that falls within a predetermined region.

In this configuration, identification of a touch input as a touch gesture is performed using, as positions for identification, positions which are among contact positions detected within a predetermined time and excludes contact positions detected after a total number of contact positions that are detected after a start of the touch input reaches a predetermined number and fall within a predetermined region. A user often gives a touch input with an intention for a certain time after the start of the touch input, but the input may be followed by an unintended input. Such unintended inputs are often given in a predetermined region. In consideration of this, the touch input is identified as a touch gesture using only a predetermined number of contact positions detected after the start of a touch input and not using contact positions that are detected after a total number of contact positions detected after the start of the touch input reaches a predetermined number and that falls within a predetermined region where unintended inputs are often detected. This allows more appropriate selection of items of detection information to use provided from the touch sensor. As a result, detected touch gestures matches touch gesture intended by users more accurately, and thereby capability of identifying touch gesture inputs is increased.

Furthermore, for example, the input processing unit may include: a detection unit configured to detect the contact positions; a first memory unit configured to store items of position information indicating associations between the contact positions detected by the detection unit within the predetermined period and the times at which the contact positions are detected; a rejection unit configured to reject a contact position when the contact position is detected by the detection unit after the total number of contact positions indicated by the position information stored in the first memory unit exceeds the predetermined number and the contact position falls within the predetermined region stored in the second memory unit; and an identification unit configured to identify the touch input as the touch gesture using two or more of the items of the position information stored in the first memory unit after the rejection.

Furthermore, for example, the input processing unit may further include a region changing unit configured to change the predetermined region stored in the second memory unit when at least one of the contact positions detected by the detection unit falls within a specific region, and the rejection unit may be configured to perform the rejection on a contact position which is detected by the detection unit after the at least one of the contact positions falls within the specific region, using the predetermined region changed by the region changing unit.

Furthermore, for example, the touch sensor may have a protrusion on a surface of the touch sensor, and the region changing unit may be configured to change the predetermined region stored in the second memory unit, when at least one of the contact positions detected by the detection unit falls within a region where the protrusion is located, the region being the specific region.

Furthermore, for example, the input processing unit may further include a region changing unit configured to change the predetermined region stored in the second memory unit when an angle between a first vector and a second vector has an absolute value larger than or equal to a predetermined angle, the first vector starting at a point indicated by a first position information item which is one of the items of the position information stored in the first memory unit and ending at a point indicated by a second position information item which is one of the items of the position information stored later than the first position information item, the second vector starting at the point indicated by the second position information item and ending at a point indicated by a third position information item which is one of the items of the position information stored later than the second position information item, and the rejection unit may be configured to perform, using the predetermined region changed by the region changing unit, the rejection on a contact position which is detected by the detection unit after the contact positions fall within the specific region.

Furthermore, for example, the second memory unit may be configured to store an edge region as the predetermined region, the edge region being predetermined as an edge of the touch sensor.

Furthermore, for example, an information input device which identifies, as a touch gesture, a touch input from a user, the information input device may include: a touch sensor; and an input processing unit configured to identify the touch input as the touch gesture using contact positions for identification among contact positions through which the touch input has been given to the touch sensor and which have been detected sequentially at different times within a predetermined period, the contact positions for identification excluding a contact position when a total number of contact positions detected after a start of the touch input reaches a predetermined number and an angle between a first vector and a second vector has an absolute value larger than or equal to a predetermined angle, the first vector starting at a point indicated by a first position information item which is one of items of stored position information at the contact positions and ending at a point indicated by a second position information item which is one of the items of the position information and stored later than the first position information item, the second vector starting at the point indicated by the second position information item and ending at a point indicated by a third position information item which is one of the items of the position information and stored later than the second position information item.

Furthermore, for example, the identification unit may be configured to identify, as the touch gesture, a linear motion having parametric information indicating a direction of the touch input and a velocity of the touch input, the direction of the touch input being calculated by approximating, by a line segment, the two or more positions for identification, and the velocity of the touch input being calculated from position information indicating the two or more positions for identification.

Furthermore, for example, the identification unit may be configured to identify, as the touch gesture, a rotational motion having parametric information indicating a direction of the touch input and a velocity of the touch input, the direction of the touch input being calculated by approximating, by an arc, three or more positions for identification among positions for identification stored in the first memory unit, and the velocity of the touch input being calculated from position information indicating the three or more positions for identification.

It should be noted that these general or specific aspects can be implemented as a system, a method, an integrated circuit, a computer program, a computer-readable recording medium such as a compact disc read-only memory (CD-ROM), or as any combination of a system, a method, an integrated circuit, a computer program, and a computer-readable recording medium.

Embodiments of the present invention shall be described below with reference to the drawings.

Each of the exemplary embodiments described below shows a general or specific example of the present invention. The values, configurations, materials, constituent elements, layout and connection of the constituent elements, steps, and the order of the steps in the embodiments are given not for limiting the present invention but merely for illustrative purposes only. Therefore, among the constituent elements in the following exemplary embodiments, constituent elements not recited in any one of the independent claims are described as arbitrary constituent elements.

### Embodiment 1

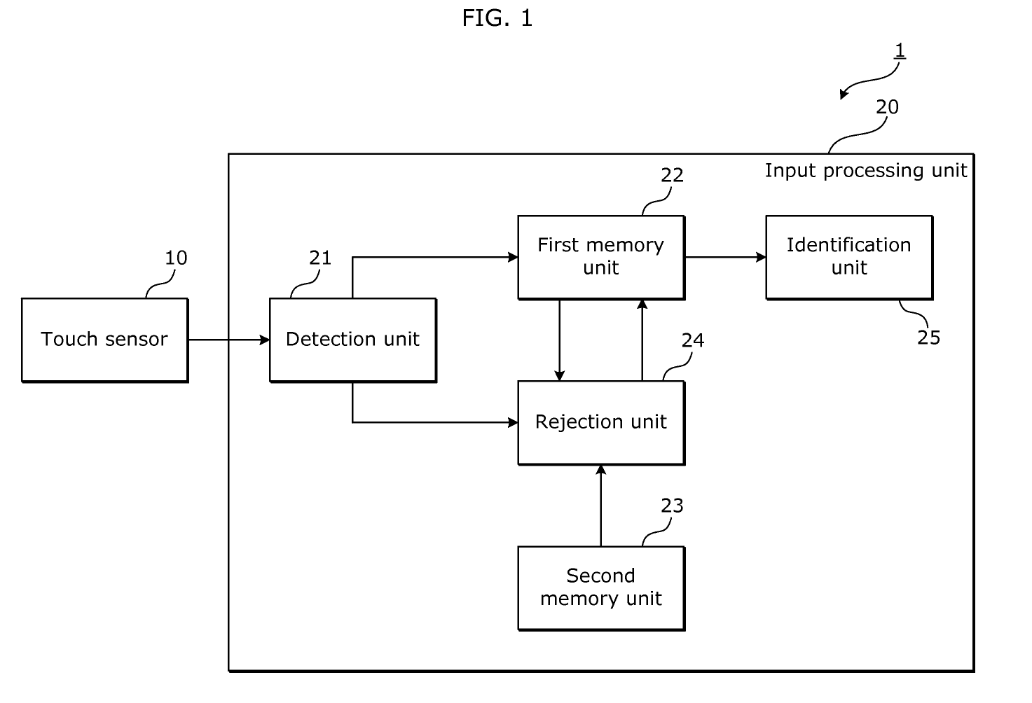

FIG. 1 is a block diagram of an information input device in an embodiment of the present invention.

An information input device 1 includes a touch sensor 10 and an input processing unit 20. The touch sensor 10 is a device which detects a position of a contact made to the surface of the touch sensor 10 with a finger or a thumb by a user, and outputs an electric signal corresponding to the position of the contact. Specifically, the touch sensor 10 can be implemented as a touchpad or a touchscreen, for an example. The touch sensor 10 may detect a finger or a thumb of a user by means of capacitive sensing, resistive sensing, surface acoustic wave, infrared, or electromagnetic induction. In the following, the present invention will be described using a capacitive touch sensor for illustrative purposes.

The input processing unit 20 includes a detection unit 21, a first memory unit 22, a second memory unit 23, a rejection unit 24, and an identification unit 25.

The detection unit 21 detects positions of contacts of a finger or a thumb of a user with the touch sensor 10 for a predetermined period of time with predetermined sampling intervals by means of an electric signal output from the touch sensor 10 which is a capacitive touch sensor. For example, the detection unit 21 detects positions of contacts (contact positions) on the touch sensor 10 with a sampling interval of 60 ms.

The detection unit 21 may be configured to detect positions of contacts with the touch sensor 10 not with constant intervals but with various intervals. For example, when a user moves a touch input faster than a predetermined threshold, the touch input may be sampled with shorter sampling intervals. When a user moves a touch input slower than a predetermined threshold, the touch input may be sampled with longer sampling intervals. Alternatively, the sampling interval may be further shortened as the speed of a touch input by a user increases. The sampling interval is thus changed dynamically according to the speed of a touch input by a user, so that intervals between detected contact positions are made more constant. This achieves both increase in sampling accuracy and reduction in electric consumption compared to detection of contact positions with constant sampling intervals. The detection unit 21 may be configured in any manner to detect a plurality of positions of touch inputs given to a touch sensor at different times in a predetermined period.

The first memory unit 22 stores items of position information indicating associations between contact positions detected by the detection unit 21 within a predetermined period and times at which the contact positions are detected.

The second memory unit 23 stores, as a rejection region, a predetermined region which is part of the entire region of the touch sensor 10. It should be noted that the wording “to store a region” means to store information indicating the region. The rejection region indicates that positions within the rejection region may not be stored in the first memory unit 22. For example, a region set as the rejection region is part of the region of the touch sensor 10 in which a user feels difficulty in touch operations or the touch sensor may detect positions less accurately than in the other region due to the characteristics of the touch sensor 10. The rejection region may be a factory-set region or may be a region set by a user as a rejection region when the user feels difficulty in touch operations in the region.

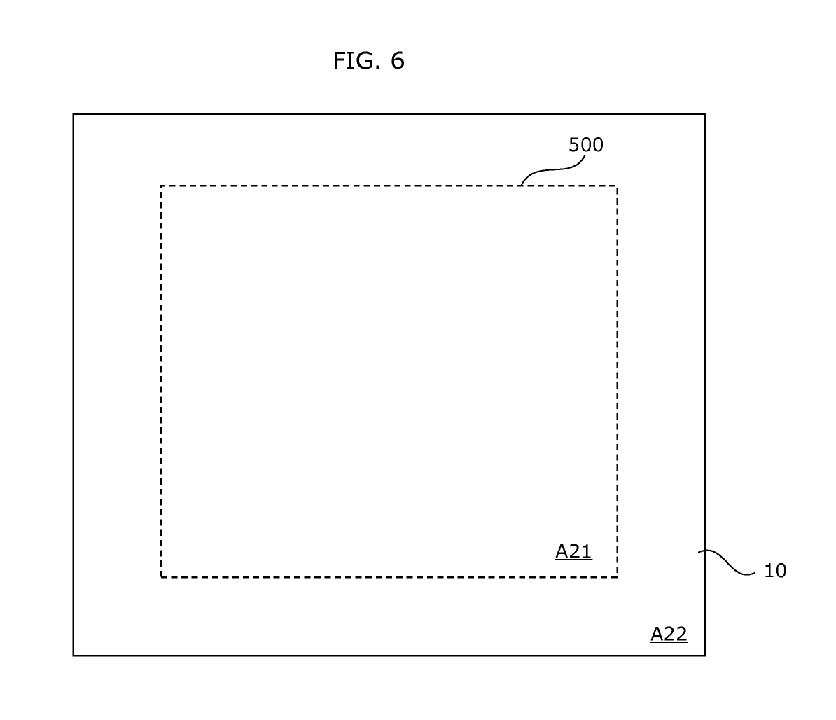

FIG. 6 illustrates a specific example of a predetermined region set as a rejection region. In FIG. 6, the region outside the rectangle defined by a border 500 of a dashed line on the touch sensor 10 is set as a rejection region A22. The region inside the rectangle defined by the dashed line on the touch sensor 10 is a main region A21, which is the region of the touch sensor 10 other than the rejection region. Especially when the portion in the vicinity of the touch sensor 10 is a rise higher than the touch sensor 10, a flick made by a user with a finger or a thumb is likely to be diverted midway when, for example, part of the finger hits against the rise. In this manner, a user may fail to perform an intended touch operation and the operation may be falsely recognized as an input. Accordingly, setting the region outside the rectangle defined by the dashed line on the touch sensor 10, that is, an edge region as a rejection region effectively reduces such false detection.

For another example, when the touch sensor is a capacitive touch sensor as described in Embodiment 1, a rejection region is a region where a conductive film provided to detect the capacitance of a finger or a thumb is thinner than in the other region.

The rejection unit 24 rejects a contact position when the contact position is detected by the detection unit 21 after the number of contact positions indicated by position information stored in the first memory unit 22 exceeds a predetermined number and the contact position falls within a predetermined region stored in the second memory unit 23. More specifically, the rejection unit 24 performs region determination to determine whether or not a position (contact position) detected by the detection unit 21 is included in the rejection region stored in the second memory unit 23. When the result of the region determination shows that the contact position is included in the rejection region, the rejection unit 24 further performs number determination to determine whether or not the number of contact positions indicated by position information stored in the first memory unit 22 exceeds a predetermined number. When the result of the number determination shows that the number of contact positions exceeds the predetermined number, the rejection unit 24 performs rejection to avoid storing the contact position in the first memory unit 22. In other words, the rejection unit 24 performs rejection on a contact position when the contact position satisfies both the criterion for the region determination and the criterion for the number determination.

The rejection unit 24 may perform the rejection in any manner to avoid storing, in the first memory unit 22, an item of position information indicating an association of a contact position of a detected touch input when the contact position satisfies both the criterion for the region determination and the criterion for the number determination. Accordingly, there are candidate times at which the rejection unit 24 determines whether to perform rejection on position information indicating a contact position detected by the detection unit 21.

The predetermined number may be changed depending on complexity of a menu of an appliance to be operated through the information input device 1. For example, an operation to view a television program guide for the next day is less complex. Accordingly, when a television program guide on a screen is detected and the menu is determined to be less complex, the predetermined number is set at a smaller number (three, for example) because a user can easily return to previous view even after an input is falsely detected. In contrast, for example, an operation to edit a recorded program is more complex. Accordingly, when a menu to edit a recorded program on a screen is detected and the menu is determined to be complex, the predetermined number is set at a larger number (ten, for example) because a user cannot easily return to previous view after an input is falsely detected. In this manner, the predetermined number may be set to a larger number when a menu to operate a device is more complex.

A first example of the candidate times is when a finger or a thumb of a user is removed from the touch sensor 10. Then, the rejection unit 24 starts determining whether to reject items of position information stored in the first memory unit 22 with the most recent item of the position information. In other words, rejection is performed at the end of a touch input by a user. Both the region determination and the number determination are performed on detected contact positions of a touch input in ascending order from the most recent one of the contact positions. Then, the item of position information indicating an association of a contact position satisfying both the criterion for the region determination and the criterion for the number determination is removed from the position information stored in the first storage unit 22. This is how the rejection is performed.

Another example of the candidate times is when the detection unit 21 detects a contact position. Then, the rejection unit 24 determines whether to store the detected contact position in the first memory unit 22 as an item of position information. In other words, the rejection unit 24 performs rejection by avoiding storing a contact position detected by the detection unit 21 in the first memory unit 22 when the contact position satisfies both a criterion for the region determination and a criterion for the number determination.

Another example of the candidate times is when the number of items of the position information stored in the first memory unit 22 reaches or exceeds a predetermined number. The rejection unit 24 performs region determination and number determination on items of the position information stored in the first memory unit 22 in the chronological order from the most recent item, to determine whether to reject the item of the position information stored in the first memory unit 22. When a contact position satisfies the criterion for the region determination and the criterion for the number determination, the item of position information indicating an association of the contact position satisfying the criteria is removed from the position information stored in the first memory unit 22. This is how the rejection is performed.

Another example of the candidate times is a time after the number of items of the position information stored in the first memory unit 22 reaches a predetermined number. The rejection unit 24 performs region determination on each contact position detected by the detection unit 21 after the time, and performs rejection to avoid storing a contact position satisfying the criterion for the region determination in the first memory unit 22.

After the number of items of the position information stored in the first memory unit 22 reaches a predetermined number, the rejection unit 24 prevents position information detected by the detection unit 21 from being used for the identification of a touch gesture by the identification unit 25 (see below) when the detected position information has low credibility. In Embodiment 1, although rejection is performed by the rejection unit 24 when an item of position information indicating an association of a contact position detected by the detection unit 21 is included in a rejection region which is a given region, the region determination need not be a necessary condition for rejection. For example, instead of using the criterion for the region determination, a hit of a finger or a thumb against a rise or a protrusion in the vicinity of a touchpad may be detected. In this case, items of position information after the detection of the hit are rejected when the criterion for the number detection is satisfied. Optionally, a hit may be detected when an abrupt change in the direction of a motion of a finger or a thumb is detected on an assumption that the direction of a motion of a finger abruptly changes only when a finger or a thumb hits against an object. An example of a method of detecting an abrupt change in the direction of a motion of a finger or a thumb is as follows. First, an angle between a first vector and a second vector is calculated. The first vector starts at a point indicated by a first position information item which is one of items of position information stored in the first memory unit 22, and ends at a point indicated by a second position information item which is stored in the first memory unit 22 later than the first position information item. The second vector starts at the point indicated by the second position information item and ends at a point indicated by a third position information item which is stored in the first memory unit 22 later than the second position information item. Then, when the angle has an absolute value larger than or equal to a predetermined angle, an abrupt change in the direction of a motion of a finger or a thumb is detected.

The identification unit 25 identifies the type of a touch gesture by determining, using items of position information on at least two points included in position information stored in the first memory unit 22, whether or not the touch gesture is a predetermined touch gesture.

The following will specifically describe an operation of the identification unit 25.

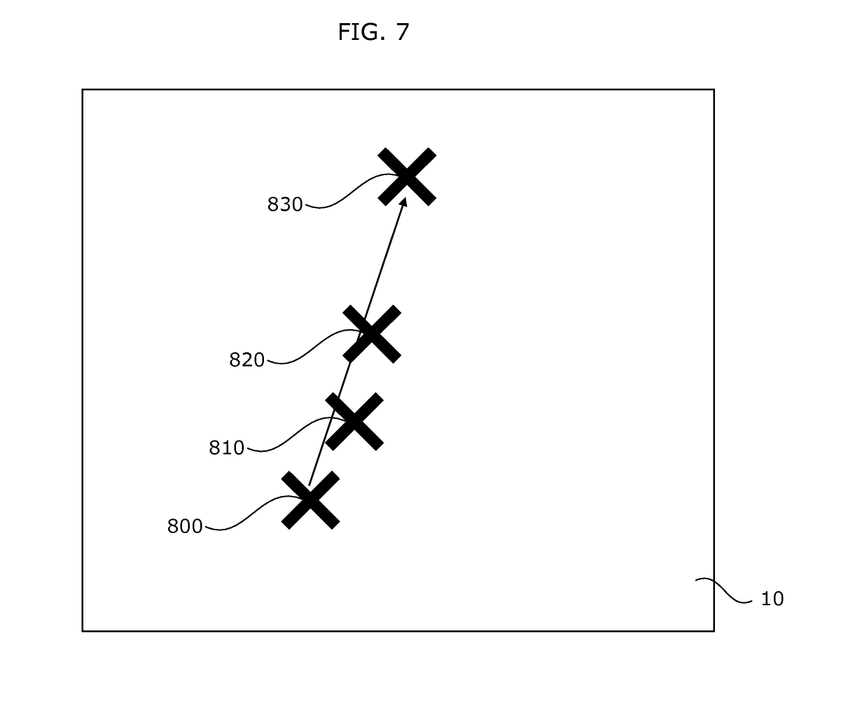

FIG. 7 illustrates detected points 800 to 830 on a path of a motion of a finger on the touch sensor 10. The detected points 800 to 830 in FIG. 7 are detected by the detection unit 21 and chronologically indicate contact positions having associations indicated by items of position information stored in the first memory unit 22. In other words, the detected points 800 to 830 are positions of a contact made by a user, and the positions are detected by the detection unit 21. When items of position information indicating associations of the detected points 800 to 830 shown in FIG. 7 are stored in the first memory unit 22, the identification unit 25 identifies a touch input given by a user as a flick.

For example, the identification unit 25 identifies whether or not a touch gesture is a flick, using two points of the detected point 800 and the detected point 830 among points indicated by items of position information stored in the first memory unit 22. The detected point 800 is a starting point that is oldest among the points indicated in the position information, and the detected point 830 is an end point that is most recent among the points indicated in the position information. The identification unit 25 calculates a velocity vector by dividing a motion vector along a line segment from the detected point 800 to the detected point 830 by a time difference between the time of storing the detected point 800 and the time of storing the detected point 830. The identification unit 25 identifies the touch gesture as a flick when the calculated velocity vector and a norm each have a value within a predetermined range.

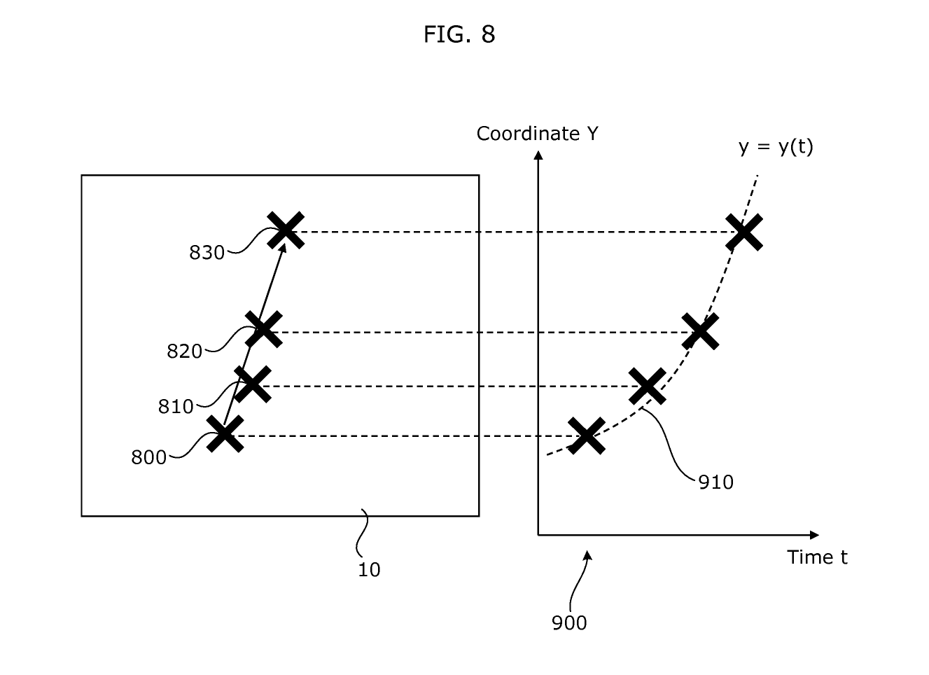

For another example, the identification unit 25 identifies whether or not a touch gesture is a flick by deriving an approximate line or an approximate curve using all items of position information. More specifically, the identification unit 25 derives an expression x(t) for a relationship between x and t and an expression y(t) for a relationship between y and t by approximation using the least-squares method with items of position information on the detected points 800 to 830 stored in the first memory unit 22 (t denotes time information, x and y denote position information in the form of (x, y)). For example, a graph 900 in FIG. 8 includes the detected points 800 to 830 mapped in a two-dimensional coordinate system having time t and a vertical axis y. A curve 910 is derived by approximating coordinates y by a quadratic expression in time t on the graph 900. Another curve can be obtained by approximating coordinates x by a quadratic expression in time t in the same manner. Then, an x component and a y component of a velocity are obtained by differentiating the expression x(t) and the expression y(t) with respect to time t, respectively. In other words, a velocity vector is obtained for each time point. The identification unit 25 thereby identifies the touch gesture as a flick when the direction of the calculated velocity vector and a norm at a time point each has a value within a predetermined range.

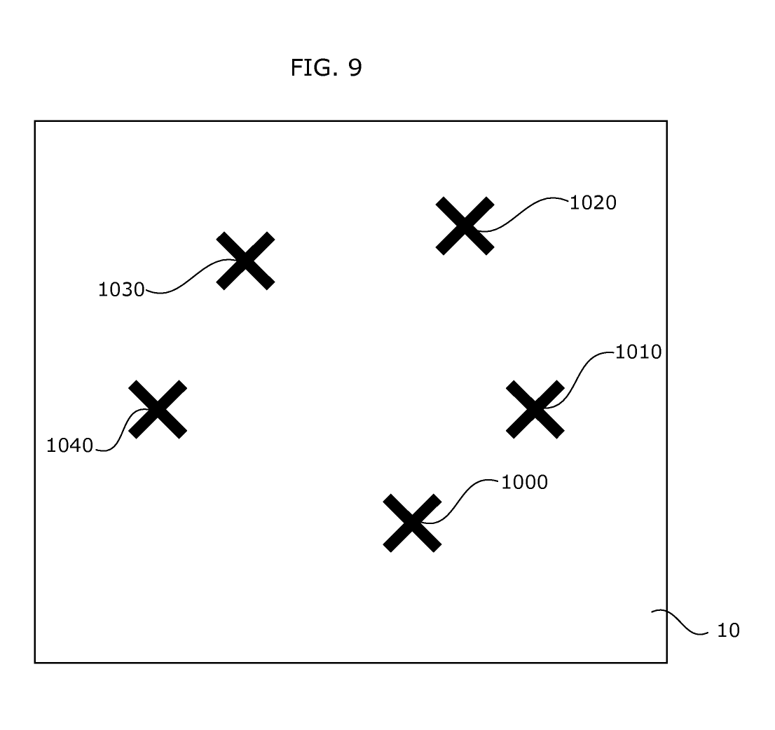

FIG. 9 illustrates detected points 1000 to 1040 on a path of a motion of a finger on the touch sensor 10. The detected points 1000 to 1040 are detected by the detection unit 21 and chronologically indicate contact positions having associations indicated by items of position information stored in the first memory unit 22. In other words, the detected points 1000 to 1040 are positions of a contact made by a user, and the points are detected by the detection unit 21. When items of position information indicating associations of the detected points 1000 to 1040 shown in FIG. 9 are stored in the first memory unit 22, the identification unit 25 identifies a touch input given by a user as a rotation.

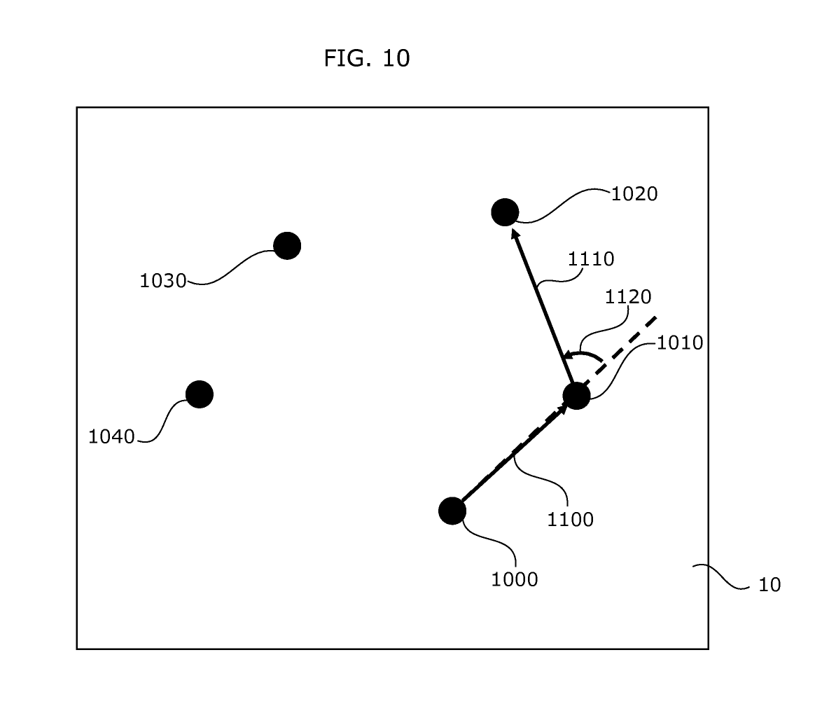

The following will specifically describe an exemplary operation of the identification unit 25 to identify a touch gesture as a rotation. The identification unit 25 calculates an angle between a first vector and a second vector. The first vector starts at a point indicated by a first item of position information stored in the first memory unit 22 and ends at a point indicated by a second item of the position information stored in the first memory unit 22 later than the first item. The second vector starts at the point indicated by the second item of the position information stored and ends at a point indicated by a third item of the position information. The third item is stored later than the second item. The operation will be specifically described using FIG. 10 as an example. The detected points 1000 to 1040 in FIG. 10 are equivalent to the detected points 1000 to 1040 in FIG. 9. An angle between a vector 1100 from the detected point 1000 to the detected point 1010 and a vector from the detected point 1010 to the detected point 1020 is calculated.

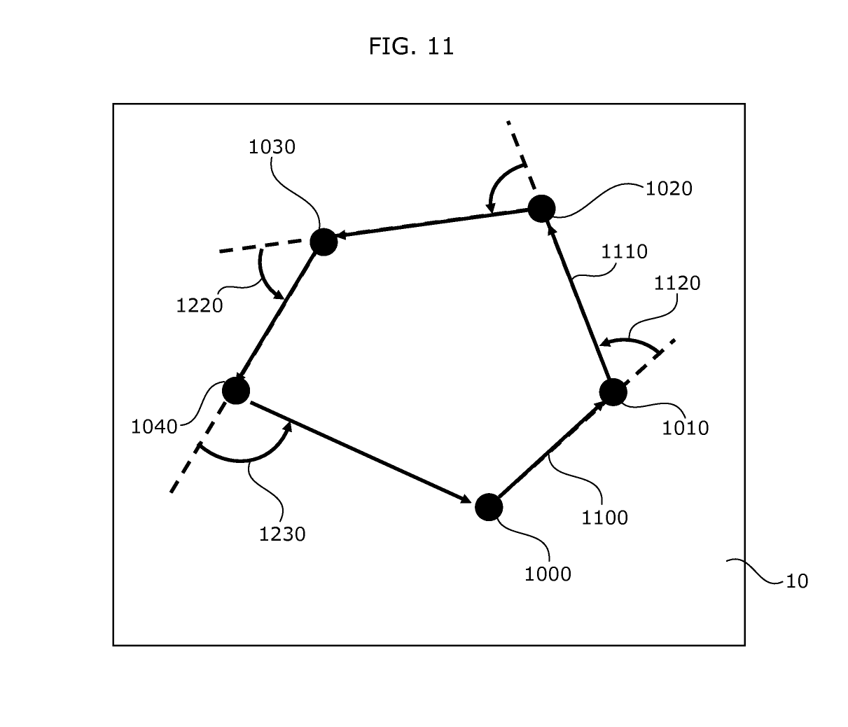

Next, an angle between the second vector and the third vector is obtained. The third vector starts at a position indicated by the third item of the position information to a fourth item of the position information stored later than the third position information. Angles between vectors subsequently stored are calculated in the same manner. The operation will be specifically described using FIG. 11 as an example. The detected points 1000 to 1040 in FIG. 11 are equivalent to the detected points 1000 to 1040 in FIG. 9 and FIG. 10. The angles between the vectors between the points are calculated as an angle 1120, an angle 1210, an angle 1220, and an angle 1230.

The identification unit identifies a touch gesture as a rotation when vectors connecting positions indicated by items of position information stored in a predetermined time are calculated using the above method and angles between the vectors are within a range, and the total of the angles reaches a predetermined value.

This is a specific example of an operation of the identification unit 25 to identify a touch gesture as a rotation.

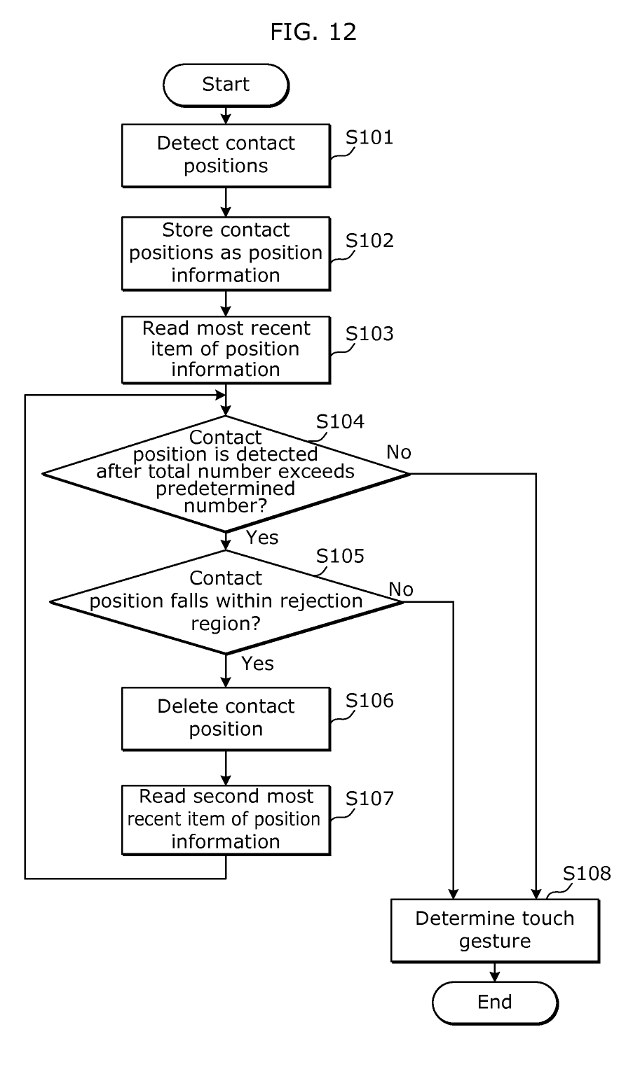

The following describes information input which the information input device performs, with reference to FIG. 12.

FIG. 12 is a flowchart indicating steps in information input processing performed by the input processing unit 20 of the information input device. In the following, rejection performed by the rejection unit 24 is described using the above-described first example of the candidate times as a time for performing rejection.

First, when a user makes a contact to a touch sensor 10, the detection unit 21 detects contact positions for a predetermined period with predetermined sampling intervals (S101).

Next, the first memory unit 22 stores items of position information indicating associations between the contact positions detected by the detection unit 21 in the predetermined period and the times at which the contact positions are detected (S102). In other words, the first memory unit 22 stores items of position information indicating associations between all the contact positions detected by the detection unit 21 within the predetermined period and times at which the contact positions are detected.

The rejection unit 24 reads the most recent item of the position information stored in the first memory unit 22 (S103).

The rejection unit 24 determines whether or not the contact position having an association indicated by the read item of the position information is detected after the total number of detected contact positions exceeds a predetermined number (S104). In other words, the rejection unit 24 performs number determination on the read item of the position information.

When determining, as a result of the number determination, that the contact position having an association indicated by the read item of the position information is detected after the total number of detected contact positions exceeds a predetermined number (S104, Yes), the rejection unit 24 determines whether or not the contact position having an association indicated by the read item of the position information falls within a rejection region (S105). In other words, the rejection unit 24 performs region determination on the contact position.

When determining, as a result of the region determination, that the contact position having an association indicated by the read item of the position information falls within the rejection region (S105, Yes), the rejection unit 24 deletes the item of the position information from the first memory unit 22 (S105). Accordingly, when the item of the position information satisfies both the criterion for the number determination and the criterion for the region determination, the item is deleted from the first memory unit 22.

Next, the rejection unit 24 reads the second most recent one of items of the position information preceding the item of the position information read in Step S106 (S107), and returns to Step S104.

When the item of the position information does not satisfy at least one of the criterion for the number determination and the criterion for the region determination (No in either or both of S104 and S105), the identification unit 25 identifies a touch gesture using two or more items of the position information stored in the first memory unit 22 (S108).

In the information input device 1 according to Embodiment 1, the rejection unit 24 rejects a contact position indicated in position information stored in the first memory unit 22 when the contact position is detected by the detection unit 21 after the number of contact positions indicated in the position information stored in the first memory unit 22 exceeds a predetermined number and the contact position falls within a predetermined region. Then, the identification unit 25 identifies a touch gesture using two or more of positions for identification having associations indicated by items of position information stored in the first memory unit 22 after the rejection performed by the rejection unit 24.

For example, assume a case as described using FIG. 4 where a user with an intention to flick upward moves a finger or a thumb from the detected point 300 to the detected point 330, and then the finger or thumb hits against a rise in the vicinity of the touch sensor at the detected point 330, so that the finger or thumb moves from the detected point 330 to the detected point 360. In this case, the rejection region stored in the second memory unit 23 lies left to and above the border line 390, and it is determined that when the first memory unit 22 stores four or more items of the position information, the fifth and subsequent items of position information detected by the rejection unit 24 is not stored in the first memory unit 22. In other words, the region left to and above the border line 390 is set as the predetermined region, and the number of four is set as the predetermined number. In this case, the identification unit 25 uses four items of position information indicating the respective detected points 300 to 330 to identify the touch gesture. The identification unit 25 thus identifies the touch gesture as an upward flick using the moving direction from the detected point 300, which is the starting point, and the detected point 330, which is the end point.

For another example, assume a case as described using FIG. 5 where a user with an intention to flick upward moves a finger or a thumb from the detected point 400 to the detected point 420, and then the finger or thumb hits against a rise in the vicinity of the touch sensor at the detected point 420, so that the finger or thumb moves from the detected point 420 to the detected point 430. In this case, the rejection region stored in the second memory unit 23 lies above the border line 470, and it is determined that when the first memory unit 22 stores three or more items of the position information, the fourth and subsequent items of position information item detected by the rejection unit 24 is not stored in the first memory unit 22. In other words, the region above the border line 470 is set as the predetermined region, and the number of three is set as the predetermined number. In this case, the identification unit 25 uses three items of position information indicating the respective detected points 400 to 420 to identify the touch gesture. The identification unit 25 thus identifies the touch gesture as an upward flick using the moving direction from the detected point 400, which is the starting point, and the detected point 420, which is the end point.

In this manner, the information input device 1 according to Embodiment 1 detects a flick and the direction of the flick as intended by a user. In contrast, with the conventional technique, the flick and the direction of the flick cannot be detected as intended by a user.

The rejection region of the information input device 1 according to Embodiment 1 is not limited to the above-described rejection region located in the vicinity of the rise in the vicinity of the touch sensor.

For example, when the touch sensor 11 has a protrusion on its surface, the rejection region may be a region around the protrusion of the touch sensor 11. Such a protrusion is provided to the touch sensor 11 as a guide for finger positions so that a user performing a pointing operation using the touch sensor 11 can feel the position of a finger or a thumb on the touch sensor 11 without looking at the touch sensor 11. When the finger or thumb of the user hits against the protrusion while the user is giving a touch input to the touch sensor 11, the finger or thumb may be diverted in a direction not intended by the user.

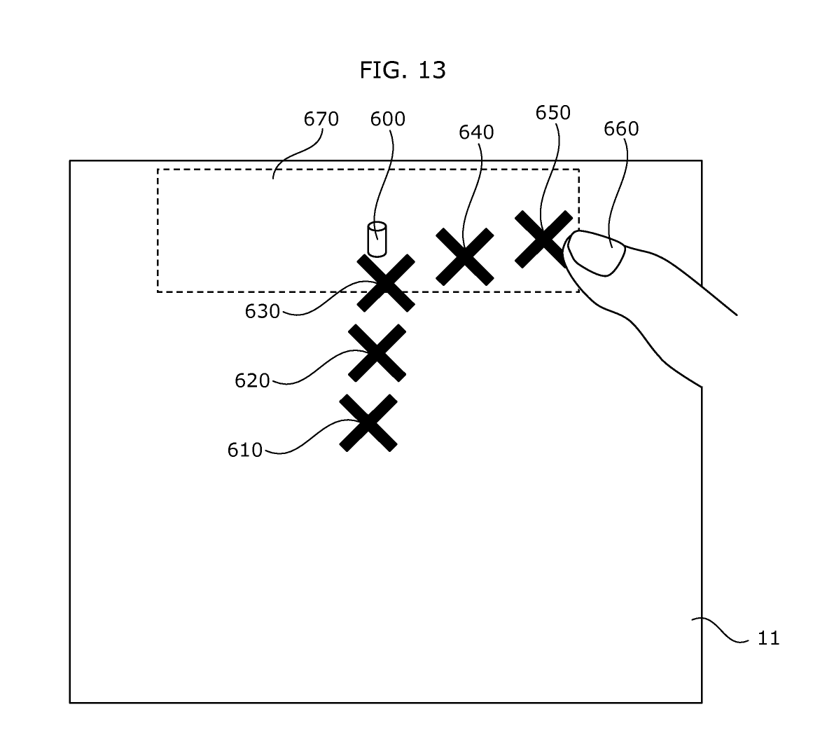

This case will be described below using FIG. 13. Assume that a protrusion 600 is provided in an upper part of the touch sensor 11. The detected points 610 to 650 are detected by the touch sensor 11 and on the path of the finger moved by a user with an intention to flick upward. The detected point 640 and the detected point 650 indicate a motion when a finger 660 hits against the protrusion 600 in the vicinity of the detected point 630 and is diverted rightward by the hitting. When the motion is identified based on the moving direction from the detected point 610, which is the starting point, and the detected point 650, which is the end point, among the detected points 610 to 650 detected by the detection unit 21, the motion is identified as a diagonal flick moved upward and rightward. In contrast, when the region inside the border line 670 is set as a rejection region, the detected point 640 and detected point 650 are candidates for items of position information to be prevented from being stored in the first memory unit 22 by the rejection unit 24. The rejection unit 24 is set to reject items of position information indicating points within the rejection region when the first memory unit 22 stores three or more items of position information.

When criteria for the region determination and the number determination of the rejection unit 24 are set in this manner, the identification unit 25 identifies the touch gesture based on the items of position information indicating the respective detected points 610 to 630 which are valid points not rejected from the first memory unit 22 by the rejection unit 24. In this case, the identification unit 25 identifies the touch gesture as an upward flick. It is thus effective to set, as a rejection region, a region around the protrusion 600 and a region through which a path of a finger or a thumb after coming into contact with the protrusion 600 may pass. This eliminates influence of a motion of a finger or a thumb not intended by a user on information to identify a touch gesture.

Optionally, the rejection region of the information input device 1 according to Embodiment 1 is not limited to a region fixed as a predetermined region as described above. The rejection region may be dynamically changed.

For example, when a finger or a thumb of a user giving a touch input passes by the protrusion 600 without coming into contact with the protrusion 600, it is unnecessary to set a region around the protrusion 600 as a rejection region. The region around the protrusion 600 may be set not as a static rejection region but as a rejection region which lasts for a predetermined time after it is determined that a finger or a thumb has come into contact with the protrusion 600.

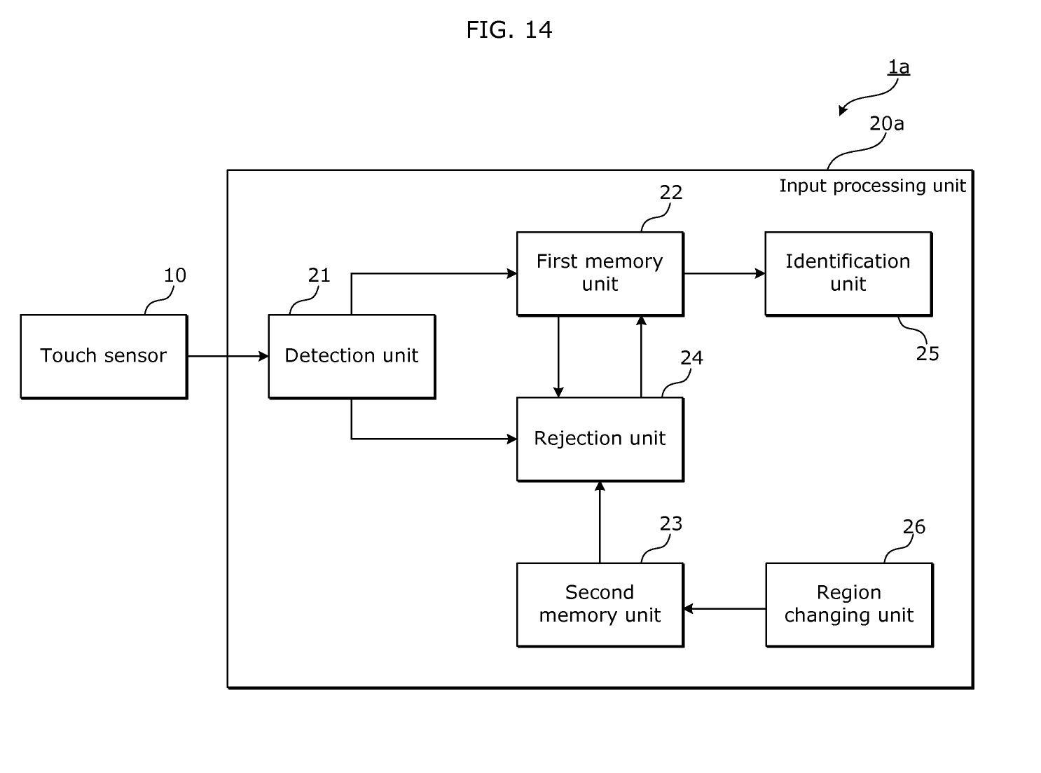

In this case, the input processing unit 20a further includes a region changing unit 26 as shown in FIG. 14. In other words, the present invention may be embodied as an information input device 1a including the input processing unit 20a. The region changing unit 26 sets a region around the protrusion 600 as a rejection region for a predetermined time after it is determined that a finger or a thumb has come into contact with the protrusion 600. In other words, the region changing unit 26 changes a predetermined region stored in the second memory unit 23 when at least one of contact positions detected by the detection unit 21 falls within a specific region. A region around a protrusion 600 may be set as a rejection region when an abrupt change in the direction of a motion of a finger or a thumb is detected. This is based on an assumption that such an abrupt change in the direction of a motion of a finger or a thumb occurs only when the finger or thumb comes into contact with the protrusion 600. For example, an abrupt change in the direction of a motion of a finger or a thumb is detected using a method as described below. First, an angle between a first vector and a second vector is calculated. The first vector starts at a point indicated by a first item of position information stored in the first memory unit 22 and ends at a point indicated by a second item of position information stored in the first memory unit 22 later than the first item. The second vector starts at the point indicated by the second item of position information stored and ends at a point indicated by a third item of position information stored in the first memory unit 22 later than the second item. When the angle has an absolute value larger than or equal to a predetermined angle, an abrupt change in the direction of a motion of a finger or a thumb is detected.

Then, using a predetermined region changed by the region changing unit 26, the rejection unit 24 performs rejection on contact positions which are detected by the detection unit 21 after a contact position falls within a specific region where the protrusion 600 is located (or a region 700 in vicinity to the protrusion 600).

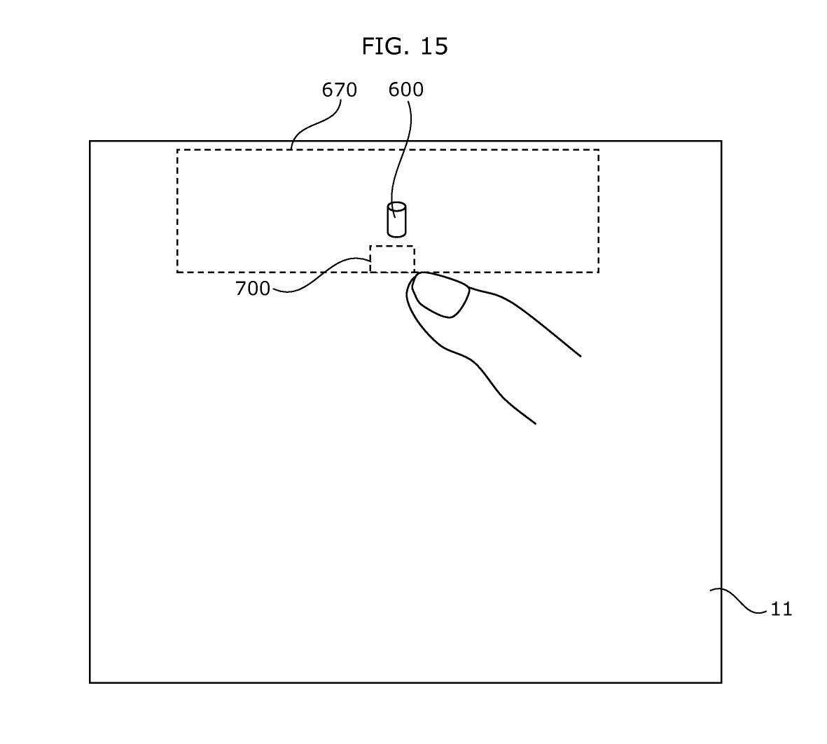

A specific behavior of the region changing unit 26 will be described below using FIG. 15. Assume that no rejection region is set in the initial state. First, a region 700 is defined in vicinity to the protrusion 600 on the touch sensor 11 shown in FIG. 15. When a contact of a finger or a thumb is detected in the region 700, the region changing unit 26 determines that the finger or thumb has come into contact with the protrusion. Then, the region changing unit 26 sets the region inside the border line 670 as a rejection region. In this operation, the region changing unit 26 does not set a rejection region when a finger or a thumb does not come into contact with the region 700 and the region changing unit 26 determines that no finger or no thumb has come into contact with the protrusion 600. Accordingly, the rejection unit 24 does not reject the position information stored in the first memory unit 22. As a result, it is possible to avoid rejection of a touch input intended by a user even when the touch input may be rejected when a rejection region is fixed. This allows identification of a touch gesture using more items of position information.

Alternatively, the input processing unit 20 of the information input device 1 according to Embodiment 1 need not be configured to include the detection unit 21, the first memory unit 22, the second memory unit 23, the rejection unit 24, and the identification unit 25. This means that the configuration of the input processing unit 20 is not limited to the above-described configuration. The input processing unit may be configured in any manner such that the input processing unit can identify a touch input as a touch gesture using contact positions for identification among contact positions detected sequentially at different times within a certain period. The contact positions are positions through which the touch input has been given to the touch sensor, and the contact positions for identification are the contact positions excluding one or more contact positions that are detected after the total number of contact positions detected after the start of the touch input reaches a predetermined number and the fall within a predetermined region.

Although the present invention is described based on the above embodiments, it should be understood that the present invention is not limited to the embodiments. The following is also within the scope of the present invention.

Specifically, the above-described device can be implemented as a computer system including a microprocessor, ROM, RAM, a hard disk unit, a display unit, a keyboard, and a mouse. The RAM or the hard disk unit stores a computer program. The microprocessor operates according to the computer program and thereby the device each performs its functions. Here, the computer program includes a combination of instruction codes to indicate instructions to the computer so that the computer performs predetermined functions.

All or part of the components of each of the devices may be composed of a system large scale integration (LSI). The system LSI is a super-multifunctional LSI manufactured by integrating constituent units on one chip, and is specifically a computer system including a microprocessor, ROM, and RAM. The ROM stores a computer program. The microprocessor loads the computer program from the ROM to the RAM, and the system LSI performs its functions by operating according to the loaded computer program.

A part or all of the constituent elements constituting the respective devices may be configured as an IC card which can be attached to and detached from the respective devices or as a stand-alone module. Each of the IC card and the module is a computer system including components such as a microprocessor, ROM, and RAM. The IC card or the module may include the above-described super-multifunctional LSI. The microprocessor operates according to the computer program, so that the IC card or the module performs its functions. The IC card or the module may be tamper-resistant.

The present invention may be implemented as the above-described method. These methods may be performed using a computer program or a digital signal indicating the computer program on a computer.

Furthermore, the present invention may also be implemented as a computer-readable recording medium, such as a flexible disk, a hard disk, a CD-ROM, an MO, a DVD, a DVD-ROM, a DVD-RAM, a BD (Blu-ray Disc), or a semiconductor memory, storing a computer program or a digital signal. Furthermore, the present invention may also be implemented as a digital signal recorded on any of these recording medium.

Furthermore, the present invention may also be implemented by way of transmission of a computer program or a digital signal via a telecommunication line, a wireless or wired communication line, a network represented by the Internet, a data broadcast, and so on.

Furthermore, the present invention may be implemented as a computer system including a microprocessor and memory. The memory stores a computer program so that the microprocessor can operate according to the computer program.

The program or the digital signal may be recorded on a recording medium for transportation or transmitted through a network or the like so that the program is executed on another independent computer system.

These embodiments and variations may be implemented in combination.

### INDUSTRIAL APPLICABILITY

The information input device according to the present invention performs touch gesture identification including rejection of a motion of a finger or a thumb not intended by a user performing a touch gesture on a touch sensor, and thereby produces an advantageous effect that the user can operate the information input device more securely. The present invention is thus applicable to an information input device and an information input method used in electronic devices.

### REFERENCE SIGNS LIST

1, 1a, 200 information input device
10, 11, 210 touch sensor
20, 20a input processing unit
21 detection unit
22 first memory unit
23 second memory unit
24 rejection unit
25 identification unit
26 region changing unit

1. An information input device which identifies, as a touch gesture, a touch input from a user, the information input device comprising:
a touch sensor; and
an input processing unit configured to identify the touch input as the touch gesture using contact positions for identification among contact positions where the touch input has been given to the touch sensor and which have been detected sequentially at different times within a predetermined period, the contact positions for identification including none of the contact positions that is detected after a total number of contact positions detected after a start of the touch input reaches a predetermined number and that falls within a predetermined region.

2. The information input device according to claim 1,
wherein the input processing unit includes:
a detection unit configured to detect the contact positions;
a first memory unit configured to store items of position information indicating associations between the contact positions detected by the detection unit within the predetermined period and the times at which the contact positions are detected;
a second memory unit configured to store the predetermined region which is part of an entire region of the touch sensor;
a rejection unit configured to reject a contact position when the contact position is detected by the detection unit after the total number of contact positions indicated by the position information stored in the first memory unit exceeds the predetermined number and the contact position falls within the predetermined region stored in the second memory unit; and
an identification unit configured to identify the touch input as the touch gesture using two or more of the items of the position information stored in the first memory unit after the rejection.

3. The information input device according to claim 2,
wherein the input processing unit further includes a region changing unit configured to change the predetermined region stored in the second memory unit when at least one of the contact positions detected by the detection unit falls within a specific region, and
the rejection unit is configured to perform the rejection on a contact position which is detected by the detection unit after the at least one of the contact positions falls within the specific region, using the predetermined region changed by the region changing unit.

4. The information input device according to claim 3,
wherein the touch sensor has a protrusion on a surface of the touch sensor, and
the region changing unit is configured to change the predetermined region stored in the second memory unit, when at least one of the contact positions detected by the detection unit falls within a region where the protrusion is located, the region being the specific region.

5. The information input device according to claim 2,
wherein the input processing unit further includes a region changing unit configured to change the predetermined region stored in the second memory unit when an angle between a first vector and a second vector has an absolute value larger than or equal to a predetermined angle, the first vector starting at a point indicated by a first position information item which is one of the items of the position information stored in the first memory unit and ending at a point indicated by a second position information item which is one of the items of the position information and stored later than the first position information item, the second vector starting at the point indicated by the second position information item and ending at a point indicated by a third position information item which is one of the items of the position information and stored later than the second position information item, and
the rejection unit is configured to perform, using a predetermined region changed by the region changing unit, the rejection on a contact position which is detected by the detection unit after the region changing unit changes the predetermined region.

6. The information input device according to claim 2,
wherein the second memory unit is configured to store an edge region as the predetermined region, the edge region being predetermined as an edge of the touch sensor.

7. An information input device which identifies, as a touch gesture, a touch input from a user, the information input device comprising:
a touch sensor; and
an input processing unit configured to identify the touch input as the touch gesture using contact positions for identification among contact positions through which the touch input has been given to the touch sensor and which have been detected sequentially at different times within a predetermined period, the contact positions for identification excluding a contact position which is detected after a total number of contact positions detected after a start of the touch input reaches a predetermined number in a rejection region set when an angle between a first vector and a second vector has an absolute value larger than or equal to a predetermined angle, the first vector starting at a point indicated by a first position information item which is one of items of position information in a first memory unit and ending at a point indicated by a second position information item which is one of the items of position information and stored later than the first position information item, the second vector starting at the point indicated by the second position information item and ending at a point indicated by a third position information item which is one of the items of position information and stored later than the second position information item.

8. The information input device according to claim 2,
wherein the identification unit is configured to identify, as the touch gesture, a linear motion having parametric information indicating a direction of the touch input and a velocity of the touch input, the direction of the touch input being calculated by approximating, by a line segment, the two or more contact positions for identification, and the velocity of the touch input being calculated from position information indicating the two or more contact positions for identification.

9. The information input device according to claim 2,
wherein the identification unit is configured to identify, as the touch gesture, a rotational motion having parametric information indicating a direction of the touch input and a velocity of the touch input, the direction of the touch input being calculated by approximating, by an arc, three or more contact positions for identification among the contact positions for identification stored in the first memory unit, and the velocity of the touch input being calculated from position information indicating the three or more contact positions for identification.

10. An information input method which is performed by an information input device which identifies, as a touch gesture, a touch input from a user, the information input method comprising:
detecting, at different times, contact positions through which the touch input is given to the touch sensor;
storing, in a first memory unit, items of position information indicating associations between the contact positions detected within a predetermined period in the detecting and the times at which the contact positions are detected;
rejecting a contact position when the contact position is detected in the detecting after a total number of contact positions indicated by the position information stored in the storing exceeds a predetermined number and the contact position falls within a predetermined region; and
identifying the touch input as the touch gesture using two or more of items of the position information stored in the first memory unit after the rejecting.

11. A non-transitory computer-readable recording medium on which a program for causing a computer to execute the detecting, the storing, the rejecting, and the identifying included in the method according to claim 10 is recorded.

12. An integrated circuit included in an information input device which identifies, as a touch gesture, a touch input from a user, the integrated circuit comprising:
a detection unit configured to detect, at different times, contact positions through which the touch input is given to the touch sensor;
a first memory unit configured to store items of position information indicating associations between the contact positions detected by the detection unit within the predetermined period and the times at which the contact positions are detected;
a second memory unit configured to store the predetermined region which is part of an entire region of the touch sensor;
a rejection unit configured to reject a contact position when the contact position is detected by the detection unit after the total number of contact positions indicated by the position information stored in the first memory unit exceeds the predetermined number and the contact position falls within the predetermined region stored in the second memory unit; and
an identification unit configured to identify the touch input as the touch gesture using two or more of the items of the position information stored in the first memory unit after the rejection.
